(19) United States
(12) Patent Application Publication
(10) Pub. No.: US 2015/0277132 A1
(43) Pub. Date: Oct. 1, 2015

(54) SPATIAL IMAGE DISPLAY APPARATUS AND SPATIAL IMAGE DISPLAY METHOD

(71) Applicant: Sony Corporation, Tokyo (JP)

(72) Inventors: Isamu Nakao, Tokyo (JP); Hiroyuki Ono, Tokyo (JP); Kazumasa Kaneda, Kanagawa (JP); Yohei Fukuma, Chiba (JP)

(73) Assignee: Sony Corporation, Tokyo (JP)

(21) Appl. No.: 14/661,094

(22) Filed: Mar. 18, 2015

(30) Foreign Application Priority Data
Mar. 27, 2014 (JP) 2014-066891

(51) Int. Cl. G02B 27/22; H04N 13/04

(52) U.S. Cl. CPC G02B 27/2278; H04N 13/0418; H04N 13/0409

(57) ABSTRACT

A spatial image display apparatus includes: a display section including a plurality of pixels disposed in a two-dimensional array, the plurality of pixels configured to radiate light rays at different radiation angles with each other respectively so as to form a planar image including a plurality of image points disposed in a two-dimensional array in a space apart from an array face of the plurality of pixels, wherein two or more predetermined number of pixels out of the plurality of pixels radiate the predetermined number of light rays so as to intersect to form one of the image points, and an interval of two adjacent light rays out of the predetermined number of light rays having passed one of the image points is equal to or less than a predetermined observation interval at a predetermined observation position.

### CROSS REFERENCE TO RELATED APPLICATIONS

This application claims the benefit of Japanese Priority Patent Application JP 2014-066891 filed Mar. 27, 2014, the entire contents of which are incorporated herein by reference.

### BACKGROUND

The present disclosure relates to a spatial image display apparatus that displays an image in a space, and a spatial image display method.

An optical system using a plane-symmetric imaging element is disclosed in Japanese Unexamined Patent Application Publication No. 2008-158114. In the optical system, an image of an object placed under the back surface of the element is formed at a position that is plane symmetric above the upper surface of the element. The substrate of the plane-symmetric imaging element used in this optical system is provided with a plurality of vertical holes having a rectangular cross-sectional view in a matrix, and two mirror surfaces perpendicular to each other, which is called a dihedral corner reflector (DCR), are formed on the inner wall of each vertical hole. In an imaging element including a dihedral corner reflector array (DCRA) element provided with a plurality of dihedral corner reflectors like this on a substrate, when light emitted from an object is transmitted through the vertical holes of the substrate, the light is reflected on the two mirror surfaces constituting the dihedral corner reflector one time on each of the mirror surfaces. Then, the reflected light forms an image at a position that is plane symmetric with respect to the substrate. As a result, for an observer, the formed image (real image) looks as if it is floating in a space above the upper surface of the imaging element.

### SUMMARY

In the plane-symmetric imaging element as described above, a real image is formed by retro-reflection on the substrate surface. As a result, the distance from an object to the substrate becomes equal to the distance from the substrate to the real image in a direction perpendicular to the substrate surface. Accordingly, if the floating feeling of a real image is attempted to be increased, the depth of the housing including the entire apparatus becomes large in proportion to the increase. Also, light rays that are not retro-reflected form a virtual image, and thus the use of the light rays is restricted. Also, it is difficult to create an imaging element including a dihedral corner reflector.

On the other hand, it is noted that there is a light-ray reproduction type method of stereoscopic displaying, which was proposed by Gabriel Lippman in 1908, and is called integral photography or integral imaging. However, in the integral imaging, which is generally noted, the amount of display data for conducting stereoscopic display increases. Also, a display device having a large number of pixels (high resolution) are demanded, and the like, and thus it is difficult to achieve the integral imaging.

It is desirable to provide a spatial image display apparatus that is small in size and is highly possible for obtaining a spatial image, and a spatial image display method.

According to an embodiment of the present disclosure, there is provided a spatial image display apparatus including: a display section including a plurality of pixels disposed in a two-dimensional array, the plurality of pixels configured to radiate light rays at different radiation angles with each other respectively so as to form a planar image including a plurality of image points disposed in a two-dimensional array in a space apart from an array face of the plurality of pixels, wherein two or more predetermined number of pixels out of the plurality of pixels radiate the predetermined number of light rays so as to intersect to form one of the image points, and an interval of two adjacent light rays out of the predetermined number of light rays having passed one of the image points is equal to or less than a predetermined observation interval at a predetermined observation position.

According to another embodiment of the present disclosure, there is provided a method of displaying a spatial image, the method including: when a plurality of pixels, disposed in a two-dimensional array, radiate light rays at different radiation angles with each other respectively so as to form a planar image including a plurality of image points disposed in a two-dimensional array in a space apart from an array face of the plurality of pixels, two or more predetermined number of pixels out of the plurality of pixels radiating the predetermined number of light rays so as to intersect to form one of the image points, and wherein an interval of two adjacent light rays out of the predetermined number of light rays having passed one of the image points is equal to or less than a predetermined observation interval at a predetermined observation position.

In a spatial image display apparatus or a method of displaying a spatial image according to the present disclosure, a planar image including a plurality of image points is formed in a space apart from an array face of a plurality of pixels. Two or more predetermined number of pixels out of the plurality of pixels radiate the predetermined number of light rays so as to intersect to form one of the image points. An interval of two adjacent light rays out of the predetermined number of light rays having passed one of the image points becomes equal to or less than a predetermined observation interval at a predetermined observation position.

With a spatial image display apparatus or a method of displaying a spatial image according to the present disclosure, when a planar image including a plurality of image points is formed in a space apart from an array face of a plurality of pixels, light rays forming each image point are optimized so that it is possible to obtain a spatial image that is small in size and is highly possible.

In this regard, the advantages described here are not limited, and any one of the advantages described in this disclosure may be sufficient.

### BRIEF DESCRIPTION OF THE DRAWINGS

FIG. 1 is a sectional view illustrating an example of a configuration of a spatial image display apparatus according to a first embodiment of the present disclosure;

FIG. 2 is a plan view illustrating an example of a pixel array;

FIG. 3 is a plan view illustrating an example of a sub-pixel array;

FIG. 4 is a sectional view illustrating a corresponding relationship between pixels and micro lenses;

FIG. 5 is a sectional view illustrating a first example of control of radiation angles of light rays by a micro lens;

FIG. 6 is a sectional view illustrating a second example of control of radiation angles of light rays by a micro lens;

FIG. 7 is a sectional view illustrating an example of light rays forming a plurality of image points in the spatial image display apparatus according to the first embodiment;

FIG. 8 is a sectional view illustrating light rays forming one image point in the spatial image display apparatus according to the first embodiment;

FIG. 9 is an explanatory diagram illustrating a display principle by the spatial image display apparatus according to the first embodiment;

FIG. 10 is a sectional view illustrating an example of a configuration of a spatial image display apparatus according to a second embodiment together with an example of light rays forming a plurality of image points;

FIG. 11 is an explanatory diagram illustrating a display principle by the spatial image display apparatus according to the second embodiment; and

FIG. 12 is a sectional view illustrating an example of a configuration of a spatial image display apparatus according to a third embodiment.

### DETAILED DESCRIPTION OF EMBODIMENTS

In the following, a detailed description will be given of embodiments of the present disclosure with reference to the drawings. In this regard, the description will be given in the following order.

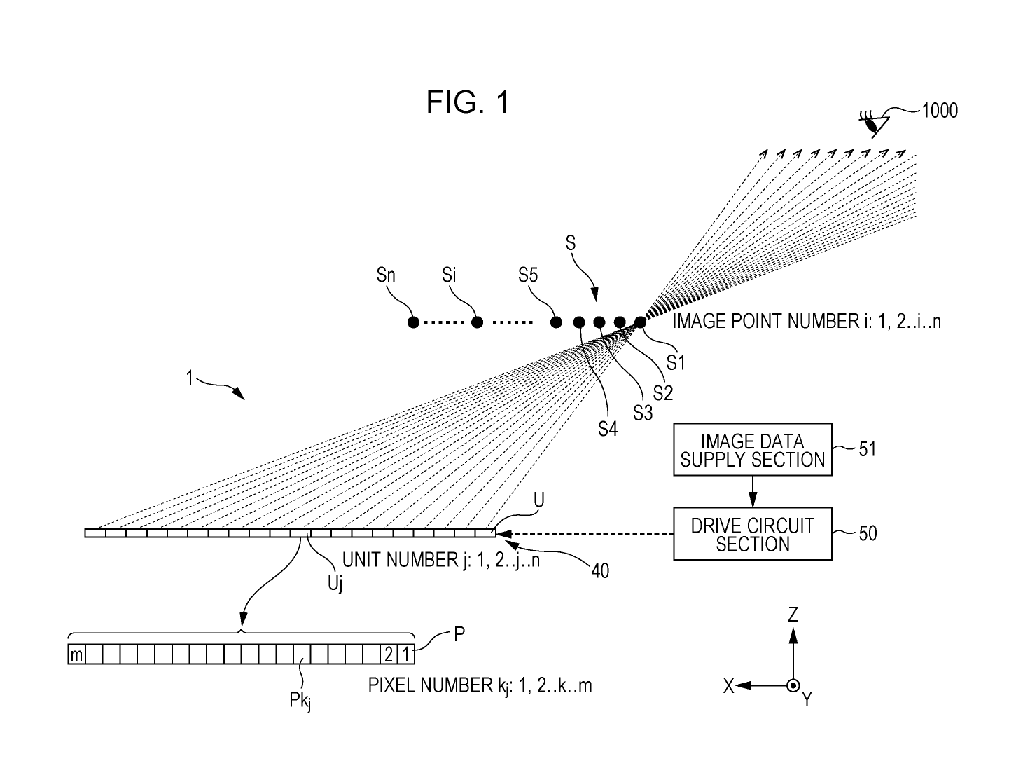

1. First embodiment (FIG. 1 to FIG. 9)
1.1 Example of overall configuration of spatial image display apparatus
1.2 Display principle
1.3 Advantages

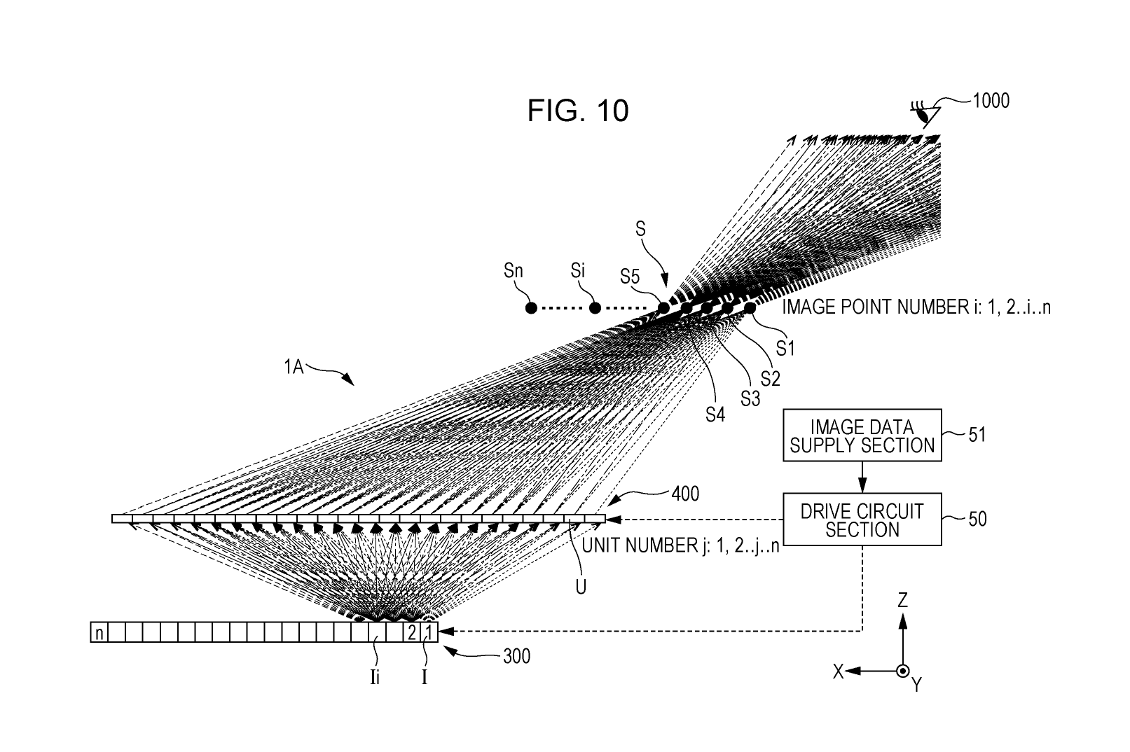

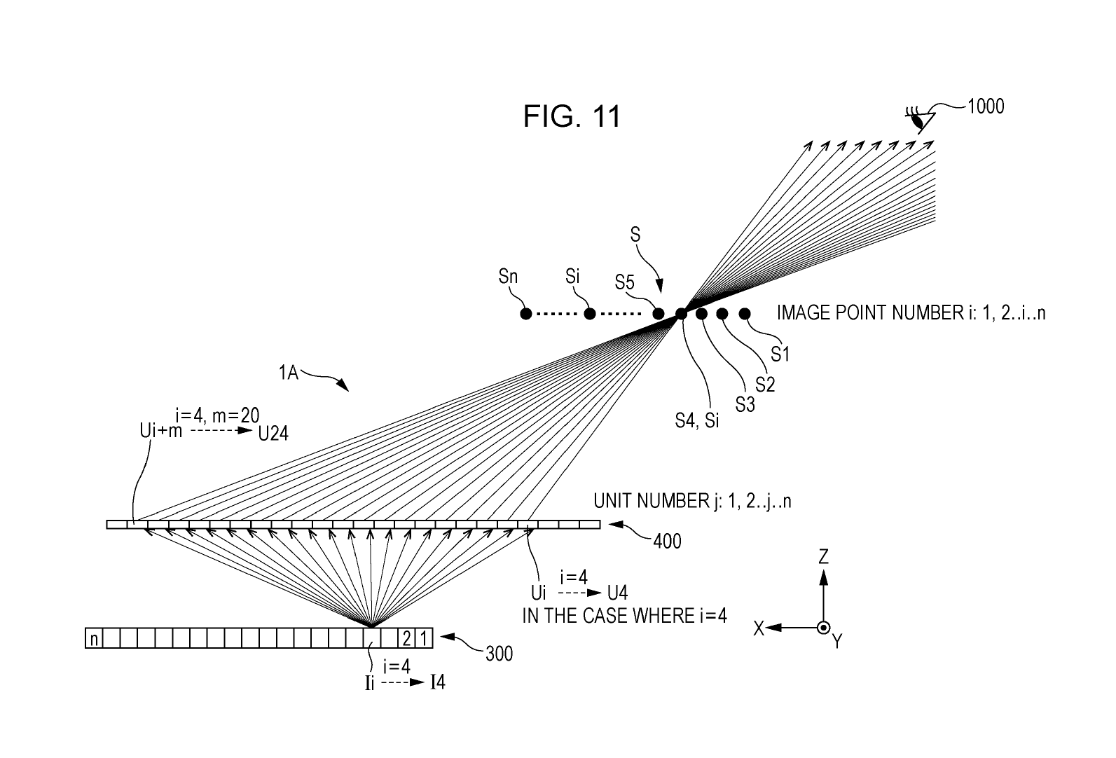

2. Second embodiment (spatial image display apparatus using hologram diffraction element) (FIG. 10 to FIG. 11)

3. Third embodiment (application of spatial image display apparatus) (FIG. 14)

4. The other embodiments

### 1. First Embodiment

1.1 Example of Overall Configuration of Spatial Image Display Apparatus

FIG. 1 illustrates an example of a configuration of a spatial image display apparatus 1 according to a first embodiment of the present disclosure. The spatial image display apparatus 1 includes a display panel 40, a drive circuit section 50, and an image data supply section 51. The display panel 40 includes a plurality of pixels P that are disposed in a two-dimensional array.

In this regard, in FIG. 1, it is assumed that a direction perpendicular to the array face of the pixels P is a Z-axis direction, and the directions that are perpendicular to each other in a parallel plane to the array face of the pixels P are an X-axis direction, and a Y-axis direction. This is the same in the subsequent other figures.

In the spatial image display apparatus 1, a plurality of pixels P radiate light rays at different radiation angles, respectively, on the display panel 40 so as to form a planar image including a plurality of image points S in a space apart from the array face of the plurality of pixels P. It is possible for an observer 1000 to recognize a planar image including a plurality of image points S as a spatial image.

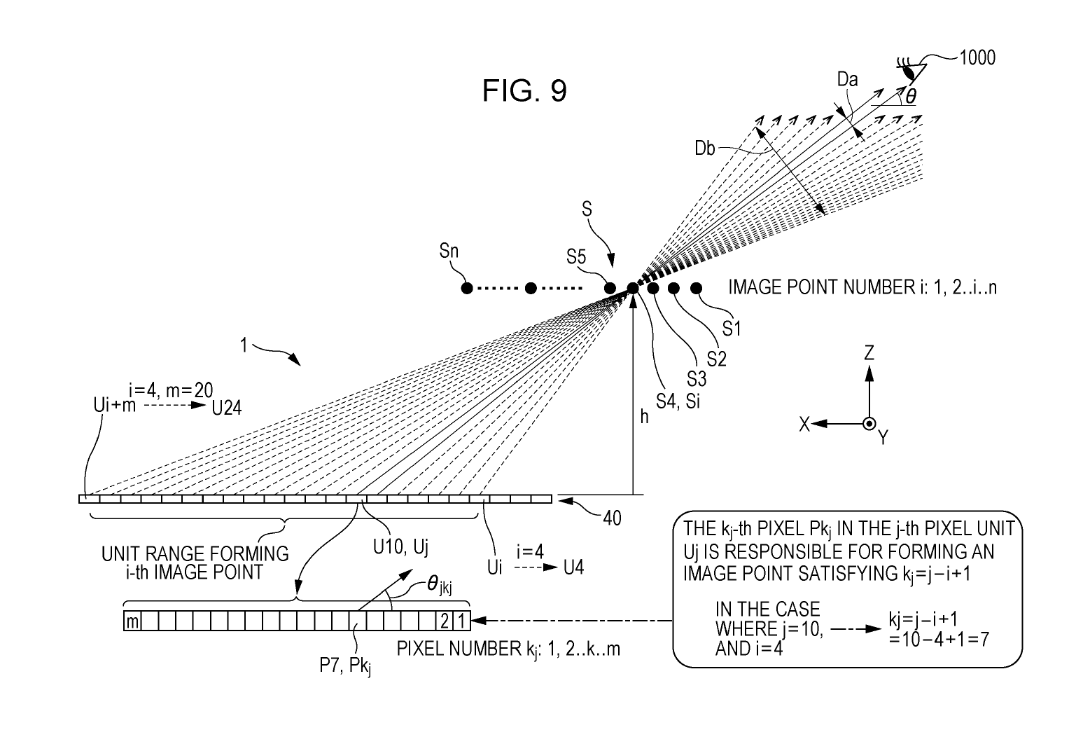

Two or more predetermined number of (m pieces of) pixels P out of the plurality of pixels P radiate a predetermined number of light rays so as to intersect to form one of the image points S. As illustrated in FIG. 9 described later, the radiation angles of light rays are controlled such that the interval Da of adjacent two light rays out of a predetermined number of light rays that have passed one of the image points S becomes equal to or less than a predetermined observation interval (the size of a pupil) at a predetermined observation position.

The display panel 40 is driven by the drive circuit section 50, and radiate light rays from the individual pixels P with light intensities based on image data from the image data supply section 51. The display panel 40 is a tabular display panel, for example a liquid crystal panel having a sufficient number of pixels, an organic EL panel, or the like.

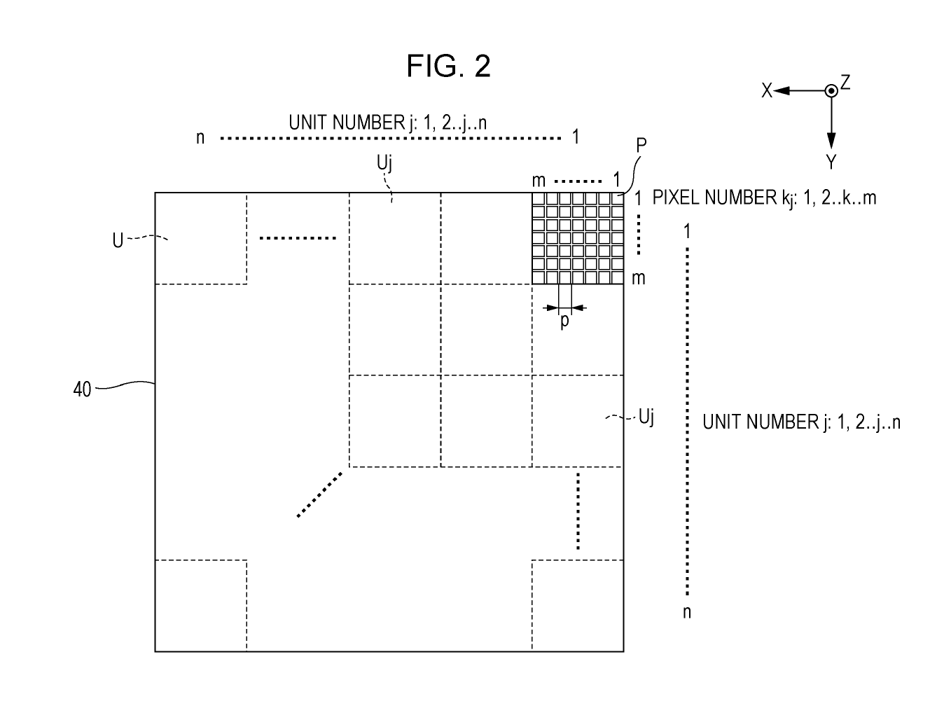

As illustrated in FIG. 2, the display panel 40 is provided with a plurality of (for example, n pieces of) pixel units U disposed in an X-axis direction and a Y-axis direction, respectively. For example, n×n pieces of pixel units U are disposed in a two-dimensional array. Also, a predetermined number of (for example, m pieces of) pixels are individually disposed in an X-axis direction and a Y-axis direction for each one pixel unit U. One pixel unit U includes m×m pixels in a two-dimensional array, for example. In this regard, FIG. 2 illustrates an example in which a substantially square display face is formed on the whole. However, the display face may be a rectangle having an XY ratio of 16:9, or the like. Also, the number of pixels included in one pixel unit U may be different in the X-axis direction, and in the Y-axis direction. Also, the number of pixel units U may be different in the X-axis direction, and in the Y-axis direction.

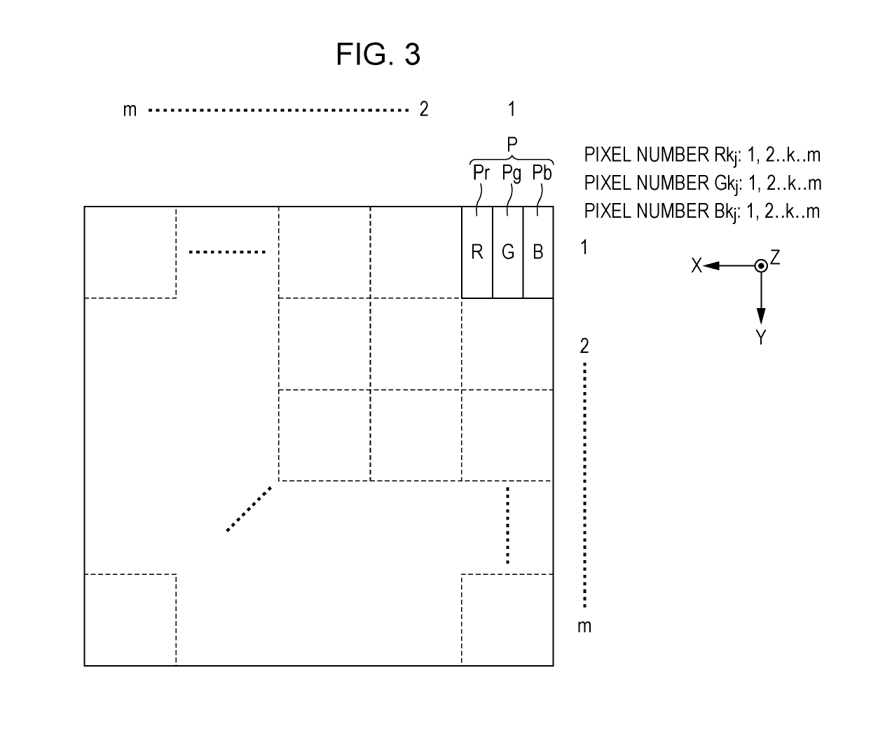

Each of the pixels P of the display panel 40 emits light rays in the visible range, for example. Thereby, it is possible for the observer 1000 to recognize a planar image in the visible range as a spatial image. As illustrated in FIG. 3, each of the pixels P may include, for example, a sub-pixel Pr that emits a R (red)-colored light ray, a sub-pixel Pg that emits a G (green)-colored light ray, and a sub-pixel Pb that emits a B (blue)-colored light ray. In this case, one pixel unit U may two-dimensionally include m×m pieces of sub-pixels for each color for example. That is to say, one pixel unit U may include 3m×m pieces of sub-pixels in total, for example. In this case, each sub-pixel emits a light ray at a different radiation angle with one another for each color so that it is possible to color display a planar image including multi-colored image points S.

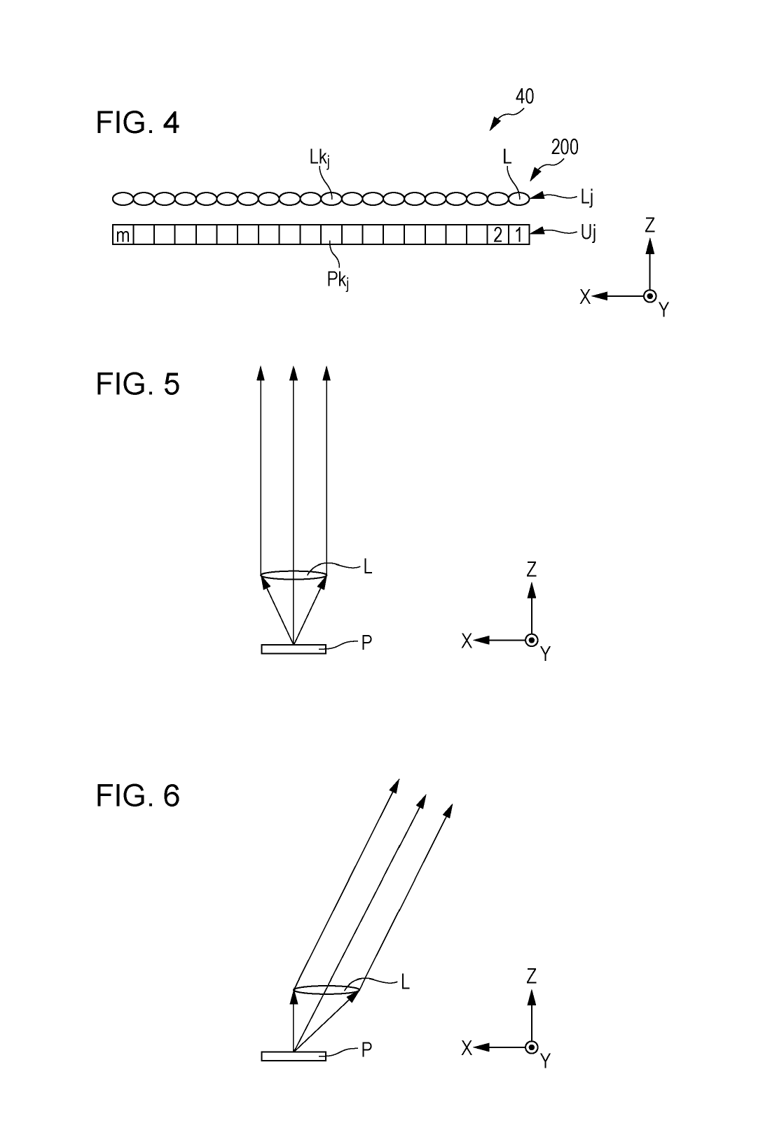

The display panel 40 may be provided with a plurality of imaging elements that control the radiation angles of the individual light rays emitted from the plurality of pixels P. For example, as illustrated in FIG. 4, a lens array 200 on which a plurality of micro lens L as imaging elements are disposed may be placed opposite to the array face of the pixels P. In this regard, the micro lenses L are disposed in a substantially same arrangement with respect to a plurality of pixels P, respectively in FIG. 4 for the sake of convenience. However, for example, as illustrated in FIG. 5 and FIG. 6, in order to make the radiation angle of a light ray for each pixel P different, the optical axis position of a micro lens L may be suitably adjusted for each pixel P. Also, for example, as illustrated in FIG. 5 and FIG. 6, it is desirable to arrange the micro lenses such that the focal plane of each micro lens L matches the light emission surface of each pixel P.

In this regard, for an imaging element that controls the radiation angle of a light ray, a Fresnel lens, a zone plate, a prism, or a diffraction element, or the like may be used in place of a micro lens L.

1.2 Display Principle

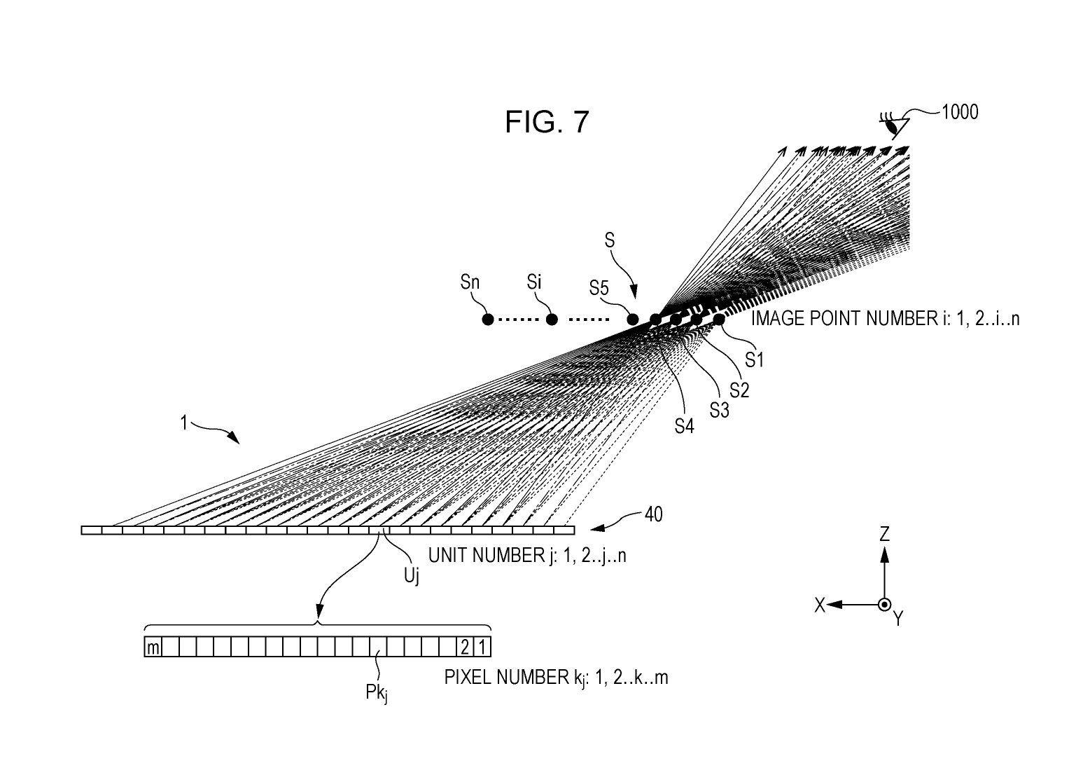

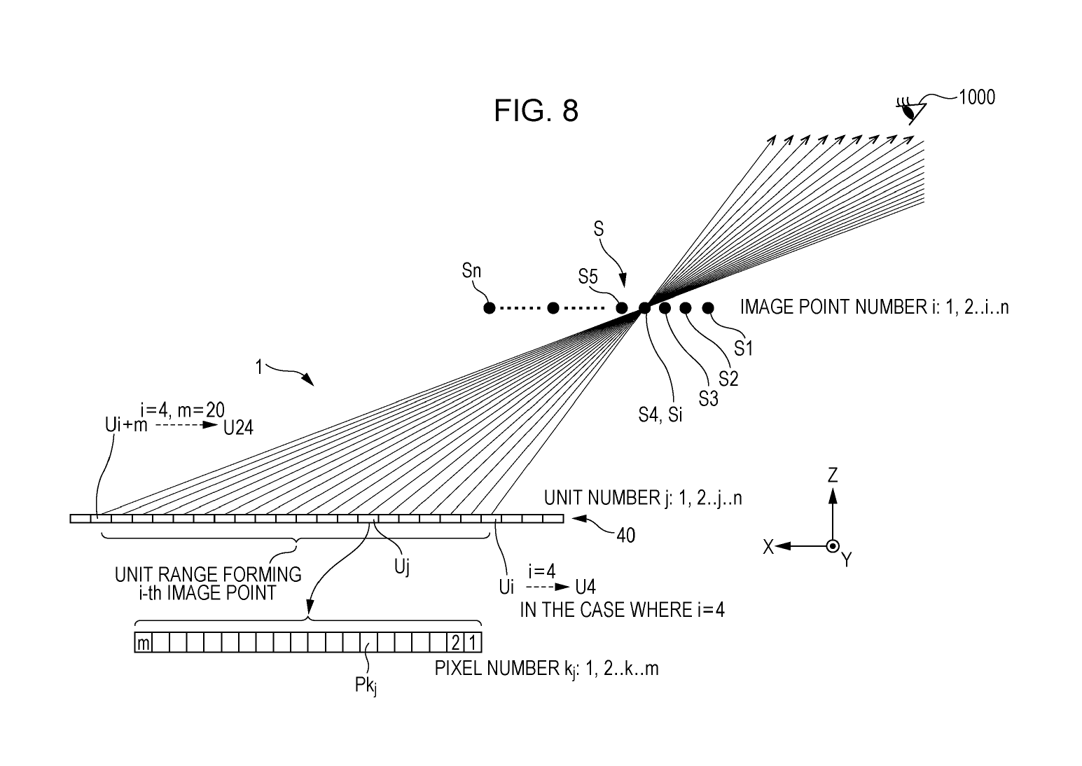

A more specific description will be given of the display principle a spatial image produced by the spatial image display apparatus 1 with reference to FIG. 7 to FIG. 9 further. FIG. 7 illustrates an example of light rays that form a plurality of image points S in the spatial image display apparatus 1. Assuming that any image point number is i, any unit number is j, and any pixel number is kⱼ, FIG. 8 and FIG. 9 illustrate an example of the light rays that form the i=4-th image point S4.

As described above, the display panel 40 includes n×n pieces of pixel units U that are disposed in a two-dimensional array, for example, and each pixel unit U includes m×m pixels that are disposed in a two-dimensional array. However, in order to make it easy to understand here, a description will be given on the assumption that each pixel unit U, and each pixel P are disposed in a one-dimensional array for simplification.

In order to form a plurality of (n (=2 or more) pieces of) image points S, the display panel 40 includes a plurality of (n pieces of) pixel units U in a one-dimensional direction, and each pixel unit U includes a predetermined number of (m (=2 or more) pieces of) pixels P in a one-dimensional direction. One image point S is formed by light rays emitted from one pixel P in each of a predetermined number of (m pieces of) adjacent pixel units U out of a plurality of (n pieces of) pixel units U.

As illustrated in FIG. 7 to FIG. 9, each of the image points S constituting a planar image formed in space is formed by the light rays emitted from m pieces of pixel units U. Assuming that the number of any pixel unit U is j, the pixel units U from j=i to the (i+m)-th are continuously responsible for the i-th image point Si. Specifically, as illustrated in FIG. 8 and FIG. 9, assuming that m=20, the pixel units from the fourth to the 24-th, U4 to U24, are responsible for the fourth image point S4, for example.

Also, any j-th pixel unit Uj is responsible for the image points S from i=j-th to the (j+m)-th. At this time, the radiation angle is controlled by an optical element, such as a micro lens L, or the like such that a light ray toward the i-th image point Si is emitted from each of the pixels P that form the i-th image point Si in all the pixel units U that form the i-th image point Si.

The pixels P in each of the pixel units U that is responsible for the i-th image point Si may be any pixel P in each of the pixel units U. However, it is convenient to dispose pixels on a regular basis in designing and manufacturing the display panel 40. For example, it is possible to set the pixel that is responsible for the i-th image point Si in the j-th pixel unit Uj to the pixel Pkⱼ of the kⱼ=(j−i+1)-th (condition 1).

Specifically, for example, as illustrated in FIG. 9, it is possible to set the pixel that is responsible for the i=4-th image point S4 in the j=10-th pixel unit U10 to the pixel P7 of the kⱼ=10−4+1=7-th. However, the number of pixels of each of the pixel units U is m, and thus the condition that 1≦kⱼ≦m is imposed (condition 2). Specifically, in the case where m=20, there are no pixels P of the 21-st and there after in each of the pixel units U, and thus the condition that 1≦kⱼ≦20 is imposed. With the combination of i and j that causes the pixel number kⱼ not to satisfy the conditions 1 and 2, the j-th pixel unit Uj is not responsible for forming the i-th image point Si.

As illustrated in FIG. 9, the angle θⱼₖⱼ of the light ray emitted from the kⱼ-th pixel Pkⱼ in the j-th pixel unit Uj is set to satisfy the following expression so that it is possible to form a planar image in a space. Here, as illustrated in FIG. 9, θ is an observation angle (90° in the case of looking down from right above), and h is an image height. As illustrated in FIG. 2, p is a length of one side of the pixel in the case where the pixel P is a square pixel.

$${θ}_{jkj} = {tan}^{- 1} \{ \frac{h}{\frac{h}{tan θ} - ( {k}_{j} - \frac{m}{2} ) p} \}$$

Specific Design Example

As the display panel 40, a 4K flat panel having a pixel pitch of 50 μm was used, and m=20 pixels in one-dimensional direction (400 pixels in two dimensions) were set to one pixel unit U. Also, m=20 pieces of (400 pieces in two dimensions) pixel units U in one-dimensional direction were designed to form one image point S, and at this time, the radiation direction of the light ray from each of the pixels P was set in accordance with the expression of the above-described angle θⱼₖⱼ such that a planar image is formed in a space that is 93.5 mm apart from the panel face.

Thereby, a planar image having a resolution of 200 pixels×100 pixels, and an image size of 198 mm×98 mm was formed at a position in a space that is 93.5 mm apart from the panel face. When this planar image was observed at the observation position that is 500 mm apart, the distance Da (refer to FIG. 9) between two adjacent light rays that pass one image point S became 4 mm at the observation position, and thus two or more light rays passed through the pupil of the observer 1000 in the case of not extremely light so as to allow the observer 1000 to recognize the image point S in a space.

Also, the Db range of the spread of all the light rays that had passed one image point S (refer to FIG. 9) became 80 mm at the above-described observation position. This is equal to or more than the binocular distance (pupillary distance) of a normal human being, and thus it was possible for the one observer 1000 to observe one image point S by both eyes at the same time. Also, by performing modulation on all the pixels P scattered over the 400 pixel units U forming the single image point S at the same time, and modulation on the light intensity emitted from the pixels P in accordance with each image point S, it was possible to display an any desired planar image. By performing modulation in accordance with RGB color signals, it was possible to display a planar image in any desired colors.

1.3 Advantages

With the present embodiment, when a planar image formed by a plurality of image points S is formed in a space that is apart from the array face of the pixels P, the light rays forming each image point S are optimized, and thus it is possible to obtain a spatial image that is small in size and is highly possible. In particular, by limiting the positions of all the image points S on a plane, and by limiting the range of forming image points S to a natural movement range of the eyes of the single observer 100, it is possible to reduce the amount of data and the number of display pixels, and to form a two-dimensional spatial image having a high resolution in the horizontal direction and the vertical direction compared with a display method by normal integral imaging, which forms a three-dimensional image.

In this regard, the advantages described in this specification are only examples, thus are not limited, and the other advantages may be included. This is the same in the other embodiments.

### 2. Second Embodiment (Spatial Image Display Apparatus using Hologram Diffraction Element)

Next, a description will be given of a spatial image display apparatus according to a second embodiment of the present disclosure. In this regard, in the following, a same symbol is given to a substantially same part as a component in the spatial image display apparatus according to the first embodiment, and the description thereof is suitably omitted.

FIG. 10 illustrates an example of a configuration of a spatial image display apparatus 1A according to the present embodiment. FIG. 10 also illustrates the light rays forming a plurality of image points S in the spatial image display apparatus 1A. Also, FIG. 11 illustrates an example in which only the light rays forming the i=4-th image point S4 is displayed in order to explain the principle of the spatial image display apparatus 1A.

Compared with the configuration of the spatial image display apparatus 1 according to the first embodiment, the spatial image display apparatus 1A according to the present embodiment includes a point light source array 300, and a hologram diffraction element 400 as a display element in place of the display panel 40. The point light source array 300 and the hologram diffraction element 400 constitute a display section.

The point light source array 300 includes a plurality of point light sources I disposed in a two-dimensional array. The point light source array 300 irradiates illumination light to a plurality of pixels P made of hologram diffraction elements 400. The hologram diffraction element 400 includes a plurality of pixels P, and controls the illumination light from the point light source array 300 such that the illumination light is to be emitted as light rays having different radiation angles at a plurality of individual pixels P.

The display principle of a spatial image by the spatial image display apparatus 1A is basically the same as that of the first embodiment. To give a simplified explanation in one dimension on the arrays of each pixel unit U and each pixel P, the hologram diffraction element 400 includes a plurality of (n pieces of) pixel units U in a one-dimensional direction, and each pixel unit U includes a predetermined number of (m (=2 or more) pieces of) pixels P in a one-dimensional direction in order to form a plurality of (n (=2 or more) pieces of) image points S in a one-dimensional direction. One image point S is formed by light rays individually emitted from each one pixel P in the predetermined number of (m pieces of) adjacent pixel units U out of the plurality of (n pieces of) pixel units U.

Individual light sources I of the point light source array 300 correspond to respective image points S. One light source I out of the plurality of light sources I emits illumination light to a predetermined number of (m pieces of) pixel units U out of the plurality of (n pieces of) pixel units U. Each of the pixel units U is illuminated with illumination light by free space radiation. For example, if it is assumed that m=20 pieces, as illustrated in FIG. 11, the fourth to the 24-th pixel units, U4 to U24, are responsible for the fourth image point S4. In this case, the i=4-th light source 14 emits illumination light to the fourth to the 24-th pixel units, U4 to U24, in order to form the fourth image point S4.

In this regard, in place of the hologram diffraction element 400, a very little mirror array for controlling the radiation direction of the light ray from each light source I, or the other diffraction element array may be disposed.

Specific Design Example

For example, the hologram diffraction element 400 is disposed at 10 mm above the point light source array 300 in which the point light sources I are disposed two-dimensionally at intervals of 2 mm. The hologram diffraction element 400 may have the same shape for each pixel unit U. Each of the pixel units U of the hologram diffraction element 400 is designed by iterative Fourier transform calculation such that the light rays from the point light source array 300 are diffracted at different angles from the incident angles and emitted. Thereby, it is possible to generate a planar image in a space.

### 3. Third Embodiment (Application of Spatial Image Display Apparatus)

It is possible to apply the spatial image display apparatuses 1 or 1A according to the first or the second embodiment, respectively, to the following fields, for example.

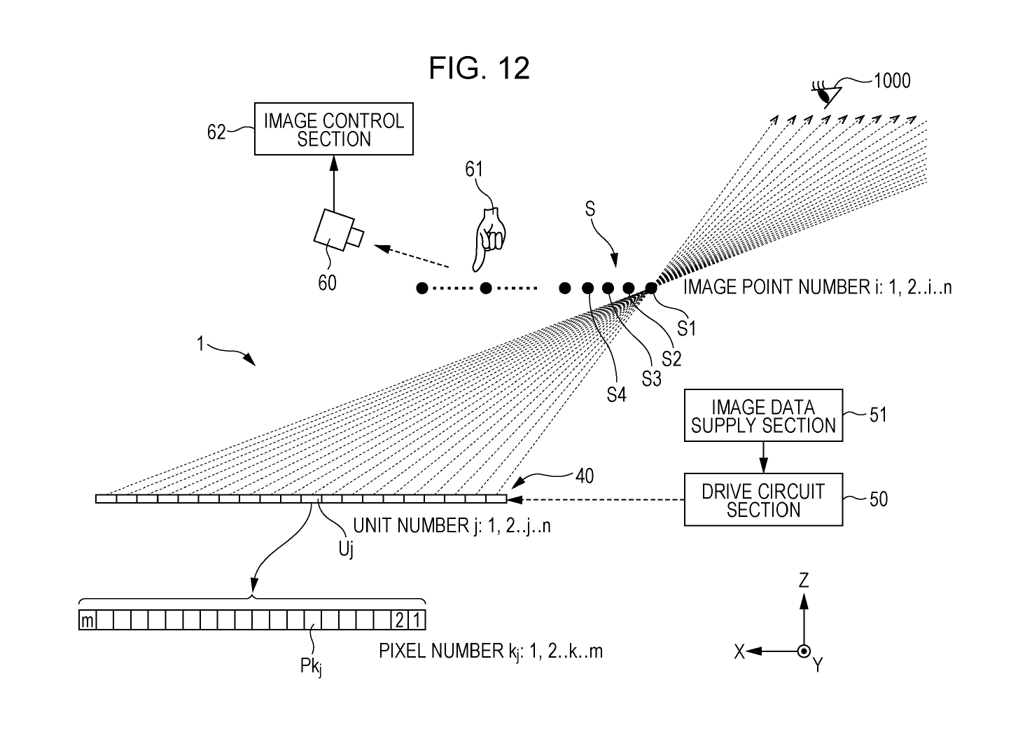

In this regard, as illustrated in FIG. 12, the spatial image display apparatus 1 or 1A according to the first or the second embodiment, respectively, may further be provided with a detection section 60 as a space position sensor that detects a pointing object 61, such as a finger, or the like, and an image control section 62 that controls the contents of the display image of the display section on the basis of a detection result of the detection section 60. Thereby, it is possible to perform the same pointing operation on a spatial image (a planar image including a plurality of image points S) as a sense of gesture operation using a finger, or the like on a touch panel of a tablet terminal, or the like, for example. Thereby, it is possible to provide not only image display, but also interactive information display.

It is possible to apply such an interactive information display to a display unit in a medical field, for example. For example, at medical services and medical examination sites in a medical field, if a doctor who has touched a patient with a gloved hand then touches an object other than the patient, it might cause infection. With the use of an interactive image interface using a spatial image, such as a spatial image display apparatus according to the present disclosure, there becomes no such risk.

Also, it is possible to apply the spatial image display apparatus according to the present disclosure to a digital signage (an electronic billboard), such as a poster, a guide plate, and the like.

Also, it is possible to apply the spatial image display apparatus according to the present disclosure to an in-vehicle display unit, such as a car navigation system, a head up display, and the like.

Also, it is possible to apply the spatial image display apparatus according to the present disclosure to a safety sign on a road, or the like. Spatial images are used for safety signs on a road, and or like, so that it is possible to achieve a display that does not hinder traffic.

### 4. The Other Embodiments

The technique according to this disclosure is not limited to the above-described embodiments, and it is possible to make various variations.

For example, it is possible to configure the present technique as follows.
(1) A spatial image display apparatus including:

a display section including a plurality of pixels disposed in a two-dimensional array, the plurality of pixels configured to radiate light rays at different radiation angles with each other respectively so as to form a planar image including a plurality of image points disposed in a two-dimensional array in a space apart from an array face of the plurality of pixels,

wherein two or more predetermined number of pixels out of the plurality of pixels radiate the predetermined number of light rays so as to intersect to form one of the image points, and

an interval of two adjacent light rays out of the predetermined number of light rays having passed one of the image points is equal to or less than a predetermined observation interval at a predetermined observation position.
(2) The spatial image display apparatus according to (1),

wherein the display section includes a plurality of pixel units,

each of the pixel units includes the predetermined number of pixels, and

out of the plurality of pixel units, light rays radiated from one pixel in each of the predetermined adjacent pixel units form one of the image points.
(3) The spatial image display apparatus according to (1) or (2),

wherein the display section includes

a display panel including the plurality of pixels disposed in a two-dimensional array, and

a plurality of imaging elements configured to control radiation angles of individual light rays radiated from the plurality of pixels.
(4) The spatial image display apparatus according to any one of (1) to (3),

wherein the display section includes

a light source array including a plurality of light sources disposed in a two-dimensional array, and configured to emit illumination light to the plurality of pixels, and

a display element including the plurality of pixels, and configured to control the illumination light to be radiated from the plurality of pixels as individual light rays having different radiation angles with each other.
(5) The spatial image display apparatus according to (4),

wherein the display section includes a plurality of pixel units,

each of the pixel units includes the predetermined number of pixels,

out of the plurality of pixel units, light rays radiated from one pixel in each of the predetermined adjacent pixel units form one of the image points, and

one light source out of the plurality of light sources emits the illumination light to the predetermined number of pixel units out of the plurality of pixel units.
(6) The spatial image display apparatus according to any one of (1) to (5),

wherein the predetermined observation interval is a size of a pupil.
(7) The spatial image display apparatus according to any one of (1) to (6),

wherein at the predetermined observation position, a size of a spread of all the predetermined number of light rays having passed one of the image points is equal to or wider than an interval of both eyes.
(8) The spatial image display apparatus according to any one of (1) to (7),

wherein each of the pixels includes a plurality of sub-pixels configured to emit different color light rays with each other, and the plurality of sub-pixels emit light rays at different radiation angles, respectively so as to form a planar image including image points of a plurality of colors in a space apart from an array face of the plurality of pixels.
(9) A method of displaying a spatial image, the method including:

when a plurality of pixels, disposed in a two-dimensional array, radiate light rays at different radiation angles with each other respectively so as to form a planar image including a plurality of image points disposed in a two-dimensional array in a space apart from an array face of the plurality of pixels,

two or more predetermined number of pixels out of the plurality of pixels radiating the predetermined number of light rays so as to intersect to form one of the image points, and

wherein an interval of two adjacent light rays out of the predetermined number of light rays having passed one of the image points is equal to or less than a predetermined observation interval at a predetermined observation position.

What is claimed is:

1. A spatial image display apparatus comprising:
a display section including a plurality of pixels disposed in a two-dimensional array, the plurality of pixels configured to radiate light rays at different radiation angles with each other respectively so as to form a planar image including a plurality of image points disposed in a two-dimensional array in a space apart from an array face of the plurality of pixels,
wherein two or more predetermined number of pixels out of the plurality of pixels radiate the predetermined number of light rays so as to intersect to form one of the image points, and
an interval of two adjacent light rays out of the predetermined number of light rays having passed one of the image points is equal to or less than a predetermined observation interval at a predetermined observation position.

2. The spatial image display apparatus according to claim 1,
wherein the display section includes a plurality of pixel units,
each of the pixel units includes the predetermined number of pixels, and
out of the plurality of pixel units, light rays radiated from one pixel in each of the predetermined adjacent pixel units form one of the image points.

3. The spatial image display apparatus according to claim 1,
wherein the display section includes
a display panel including the plurality of pixels disposed in a two-dimensional array, and
a plurality of imaging elements configured to control radiation angles of individual light rays radiated from the plurality of pixels.

4. The spatial image display apparatus according to claim 1,
wherein the display section includes
a light source array including a plurality of light sources disposed in a two-dimensional array, and configured to emit illumination light to the plurality of pixels, and
a display element including the plurality of pixels, and configured to control the illumination light to be radiated from the plurality of pixels as individual light rays having different radiation angles with each other.

5. The spatial image display apparatus according to claim 4,
wherein the display section includes a plurality of pixel units,
each of the pixel units includes the predetermined number of pixels,
out of the plurality of pixel units, light rays radiated from one pixel in each of the predetermined adjacent pixel units form one of the image points, and
one light source out of the plurality of light sources emits the illumination light to the predetermined number of pixel units out of the plurality of pixel units.

6. The spatial image display apparatus according to claim 1,
wherein the predetermined observation interval is a size of a pupil.

7. The spatial image display apparatus according to claim 1,
wherein at the predetermined observation position, a size of a spread of all the predetermined number of light rays having passed one of the image points is equal to or wider than an interval of both eyes.

8. The spatial image display apparatus according to claim 1,
wherein each of the pixels includes a plurality of sub-pixels configured to emit different color light rays with each other, and the plurality of sub-pixels emit light rays at different radiation angles, respectively so as to form a planar image including image points of a plurality of colors in a space apart from an array face of the plurality of pixels.

9. A method of displaying a spatial image, the method comprising:
when a plurality of pixels, disposed in a two-dimensional array, radiate light rays at different radiation angles with each other respectively so as to form a planar image including a plurality of image points disposed in a two-dimensional array in a space apart from an array face of the plurality of pixels,
two or more predetermined number of pixels out of the plurality of pixels radiating the predetermined number of light rays so as to intersect to form one of the image points, and
wherein an interval of two adjacent light rays out of the predetermined number of light rays having passed one of the image points is equal to or less than a predetermined observation interval at a predetermined observation position.
